(19) United States
(12) Patent Application Publication
(10) Pub. No.: US 2020/0219412 A1
(43) Pub. Date: Jul. 9, 2020

(54) SYSTEM AND METHOD FOR SENSOR FUSION FROM A PLURALITY OF SENSORS AND DETERMINATION OF A RESPONSIVE ACTION

(71) Applicant: Intuition Robotics, Ltd., Ramat-Gan (IL)

(72) Inventors: Roy AMIR, Mikhmoret (IL); Itai MENDELSOHN, Tel Aviv-Yafo (IL); Dor SKULER, Oranit (IL); Shay ZWEIG, Harel (IL)

(73) Assignee: Intuition Robotics, Ltd., Ramat-Gan (IL)

(21) Appl. No.: 16/737,220

(22) Filed: Jan. 8, 2020

Related U.S. Application Data
(60) Provisional application No. 62/789,736, filed on Jan. 8, 2019.

(51) Int. Cl. G09B 19/00; H04N 5/225; G06N 20/00; G09B 5/00

(52) U.S. Cl. CPC G09B 19/00; H04N 5/225; G09B 5/04; G09B 5/00; G06N 20/00

(57) ABSTRACT

A system and method for determining a responsive action based on sensor fusion, including: performing a sensor fusion on data received from a plurality of sensors to produce output fusion data; analyzing the output fusion data to determine one or more potential actionable scenarios to be selected; determining if the one or more potential actionable scenarios are to be executed; and sending commands to one or more resources to perform the one or more potential actionable scenarios.

### CROSS-REFERENCE TO RELATED APPLICATIONS

This application claims the benefit of U.S. Provisional Application No. 62/789,736 filed on Jan. 8, 2019, the contents of which are hereby incorporated by reference.

### TECHNICAL FIELD

The present disclosure relates generally to handling a plurality of inputs from different sensors, and more particularly to the processing of such inputs for the determination of an action responsive thereto.

### BACKGROUND

Many systems are configured with a plurality of sensors in general, and in particular a plurality of sensors of a variety of types, provide a significant amount of data that can be processed for the benefit of decision-making regarding particular actions resulting therefrom. Such sensors may include, without limitation, sensors such as accelerometers, temperature gauges, humidity sensors, microphones, light sensitivity detector, cameras, and so on. While many systems are confined to the benefit of a single type of sensor, others are configured to rely on the benefit provided from a plurality of different types of sensors. All of these sensors provide information that requires processing.

Sensor fusion deals with the combining of direct or indirect sensory data received from multiple sensory and data sources. By performing the fusion from all the sensory data, it is possible to reduce the uncertainty resulting from the collection of data that would otherwise be unusable or less effective. The sensor fusion allows the combination of data gathered from different types of sensors to provide information that would have been impossible, impractical, or otherwise too difficult or costly to obtain. Sensor fusion allows for the combination of data gathered directly from the sensors themselves, indirectly after certain processing or by way of a priori knowledge about the environment and human input, for the purpose of generating useful and actionable information.

Much work has been performed in the area of sensor fusion, for example, in the area of autonomous vehicles. However, such sensor fusion relates to the presence of humans within the environment of, typically, a moving vehicle. The primary concern is the safety of humans in the vicinity of the vehicle in motion. Multiple sensors, including radar, visual, infrared, and others, are used to determine the location of a human with respect of the vehicle and, respective thereto, providing inputs to the drive systems of the vehicle to avoid collision or damage to humans who are both outside and inside of the vehicle. The human-machine interaction presented by such systems tends to be limited and does not include social interaction other than preserving the lives of the humans in question. These systems are directed towards the proper and safe operation of the autonomous vehicles.

In the area of machine-man interaction there is ample opportunity for the use of sensor fusion. However, the challenges presented are significant, as vast amounts of sensory data are provided and models are necessary to be employed so that proper action can be taken based on the data collected. This would be of particular interest in cases where it is necessary to constantly adjust the actions of the machine based on human interaction that is taking place around or in it.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for determining a responsive action based on sensor fusion, including: performing a sensor fusion on data received from a plurality of sensors to produce output fusion data; analyzing the output fusion data to determine one or more potential actionable scenarios to be selected; determining if the one or more potential actionable scenarios are to be executed; and sending commands to one or more resources to perform the one or more potential actionable scenarios.

Certain embodiments disclosed herein also include a non-transitory computer readable medium having stored thereon instructions for causing a processing circuitry to perform a process, the process including: performing a sensor fusion on data received from a plurality of sensors to produce output fusion data; analyzing the output fusion data to determine one or more potential actionable scenarios to be selected; determining if the one or more potential actionable scenarios are to be executed; and sending commands to one or more resources to perform the one or more potential actionable scenarios.

Certain embodiments disclosed herein also include a system for determining a responsive action based on sensor fusion, including: a processing circuitry; and a memory, the memory containing instructions that, when executed by the processing circuitry, configure the system to: perform a sensor fusion on data received from a plurality of sensors to produce output fusion data; analyze the output fusion data to determine one or more potential actionable scenarios to be selected; determine if the one or more potential actionable scenarios are to be executed; and send commands to one or more resources to perform the one or more potential actionable scenarios.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a sensor system for performing sensor fusion for a human-machine interaction according to an embodiment.

FIG. 2 is a block diagram of a sensor fusor according to an embodiment.

FIG. 3 is an example flowchart illustrating a method of performing sensor fusion for a human-machine interaction according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

A sensor system includes a plurality of sensors of a variety of types, such as accelerometers, microphones, cameras, temperature sensors, humidity sensors, and the like. The sensor system further comprises a plurality of output devices, for example device that output audio, video, switch control, continuous controls, and other devices configured to output various signals. The plurality of sensors and the plurality of output devices are connected to a sensor fusor having an artificial intelligence (Al) processor, a processing circuitry (PC), and a memory. The sensor fusor performs an analysis of the gathered sensory data and based on the analysis provides one or more possible actionable scenarios to be processed by the PC. The scenarios may be stored in the memory and used to then control output actions by the plurality of outputs based on one or more possible actionable scenarios selected for response based on the analysis.

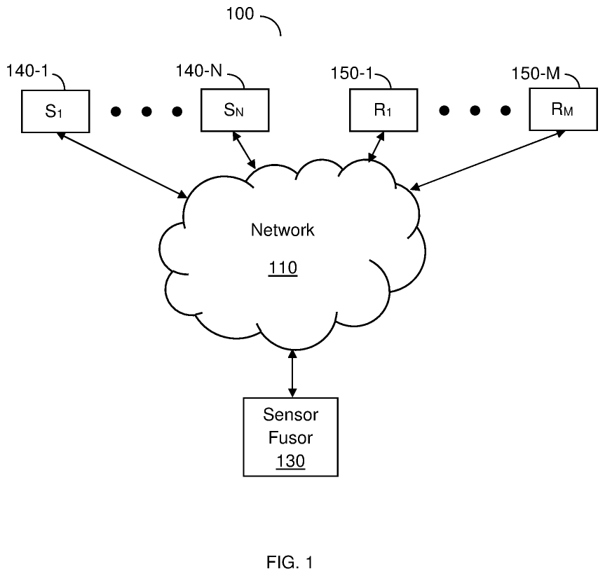

FIG. 1 is a schematic diagram of a sensor system 100 for performing sensor fusion for human-machine interaction according to an embodiment. The sensor system 100 operates as an agent, or social agent, as explained herein in more detail, and comprises a network 110, where the network 110 is used to communicate between different elements of the sensor system 100. The network 110 may be, but is not limited to, a local area network (LAN), a wide area network (WAN), a metro area network (MAN), the Internet, a wireless, cellular or wired network, an internal bus of the sensor system 100, and the like, and any combination thereof. A user of the sensor system 100 may access it directly, e.g., via a voice command or an input device connected directly or indirectly to the network 110.

A plurality of sensors 140, marked 140-1 through 140-N, where N is an integer equal to or greater than 1, allows direct or indirect inputs to the sensor system 100. For example, but not by way of limitation, communication may occur by using a microphone as a sensor 140, for example sensor 140-1. Indirect communication may happen, for example, through an application on a mobile phone (not shown) connected to a sensor 140, for example sensor 140-2 (not shown), where the sensor system 100 connects to the internet by means of the network 110. The sensor system 100 may be included, for example, as part of another device, such as a robot, a social robot, a service robot, a smart TV, a smartphone, a wearable device, a vehicle, a computer, smart appliances, and so on. Moreover, the sensor system 100 may be a combination of hardware, software and firmware operable to provide the benefits described herein in greater detail.

The sensor system 100 may further include a plurality of resources 150, marked 150-1 through 150-M, where M is an integer equal to or greater than 1. The resources 150 may include output devices, such as display units, audio speakers, lighting system, and the like. In an embodiment, the resources 150 may encompass sensors 140 as well, or vice versa. That is, a single element may have the capabilities of both a sensor 140 and a resource 150 in a single unit.

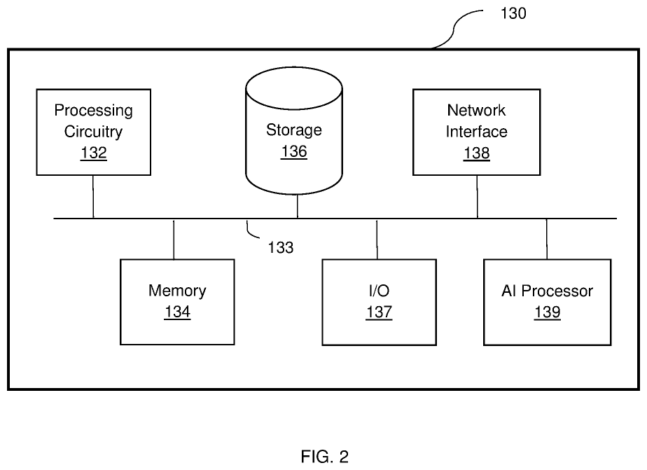

The sensor system 100 further comprises a sensor fusor 130 which may include an AI processor, discussed in more detail below in FIG. 2, which is adapted to perform sensor fusion on receive data and progressively improve the performance of the sensor system 100 based on data gathered by the sensors 140.

The sensor system 100 may be integrated into other electronic devices for the purpose of providing social interaction as described herein below in greater detail. The network 110 of the sensor system 100 may be connected wirelessly (not shown) or wired (not shown) to the Internet and the worldwide web (WWW).

A memory (not shown) may contain therein instructions that, when executed by the sensor fusor 130, cause it to execute actions as further described herein. The memory may further store therein information that may be executed by one or more of the resources 150. The resources 150 are means by which the sensor system 100 interacts with at least one person. In one embodiment, the memory may further include a database (not shown) that may store one or more actionable scenarios to be executed using the resources 150, based on determinations made by the sensor fusor 130.

The sensor fusor 130 may include hardware, software, a combination thereof, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions cause a processing circuitry 132 to perform the various processes described herein.

FIG. 2 shows an exemplary and non-limiting schematic block diagram of a sensor fusor 130 according to an embodiment. The sensor fusor 130 includes a processing circuitry 132 configured to receive data, analyze data, generate outputs, and the like, as further described herein below. The processing circuitry 132 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The sensor fusor 130 further includes a memory 134. The memory 134 may contain therein instructions that, when executed by the processing circuitry 132, cause the sensor fusor 130 to execute actions as further described herein below. The memory 134 may further store therein information, e.g., data associated with actionable scenarios that may be executed by one or more resources, e.g., the resources 150 of FIG. 1. The resources 150 may include electro-mechanical elements, sensors, detectors, display units, speakers, microphones, touch sensors, light sensors, movement detectors, cameras, and the like as discussed above in FIG. 1.

In an embodiment, the sensor fusor 130 includes a network interface 138 configured to connect to a network, such as the network 110 of FIG. 1. The network interface 138 may include, but is not limited to, a wired interface (e.g., an Ethernet port) or a wireless port (e.g., an 802.11 compliant Wi-Fi card) configured to connect to a network.

In an embodiment, the sensor fusor 130 includes an input/output (I/O) interface 137 configured to connect to and control the resources 150. In an embodiment, the I/O interface 137 is configured to receive one or more signals captured by sensors 140 and send them to the processing circuitry 132 for analysis. According to an embodiment, the I/O interface 137 is configured to analyze signals captured by the sensors 140, detectors, and the like.

In an embodiment, the sensor fusor 130 further includes an AI processor 139. The AI processor 139 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), graphics processing units (GPUs), tensor processing units (TPUs), neural processing units, vision processing unit (VPU), and the like, or any other hardware logic components that can perform calculations or other manipulations of information and may further comprise firmware and/or software components residing in a memory.

The AI processor 139 is adapted through the use of models and algorithms to provide for the specific tasks of the sensor system 100 as described herein. Specifically, the models and algorithms used to adapt the AI processor 139 are tuned to provide actionable scenario outputs that allow for the performance of human-machine interface as further discussed herein. In one embodiment, the AI processor 139 and the processing circuitry 132 are integrated into a single unit for practical implementation and design considerations.

In an embodiment, the machine learning techniques employed by the AI processor 139 include implementation of one or more neural networks, recurrent neural networks, decision tree learning, Bayesian networks, clustering, and the like, based on the data inputs.

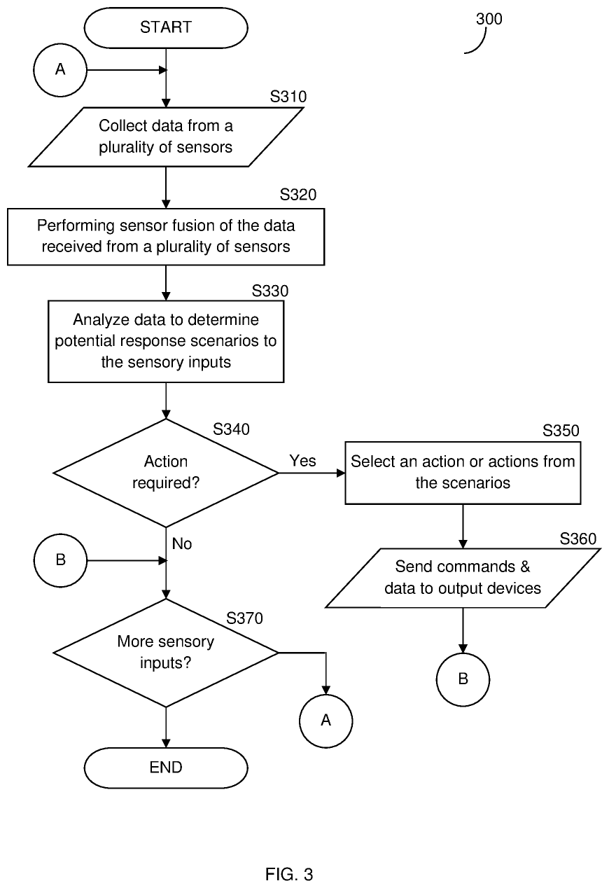

FIG. 3 is an example flowchart 300 illustrating a method for performing sensor fusion for human-machine interaction according to an embodiment.

At S310, data is collected from a plurality of sensors, e.g., the sensors 140 of FIG. 1, pertaining to a human-machine interaction. Such interaction may include a variety of use cases, examples of which are provided herein. The sensors include a variety of types, such as accelerometers, microphones, cameras, temperature sensors, humidity sensors, and the like.

At S320, sensor fusion is performed on the collected data to produce output fusion data. The sensor fusion includes applying predetermined models or algorithms that allow for an output of data having minimized uncertainty and allow for an analysis of the data collected from the sensors, e.g., using an AI processor. In an embodiment, the predetermined models are such that pertain to human-machine interactions as discussed herein below in greater detail. In a further embodiment, the sensor fusion is performed using machine learning techniques. In an embodiment, the machine learning techniques include implementation of one or more neural networks, recurrent neural networks, decision tree learning, Bayesian networks, clustering, and the like, based on the data inputs.

At S330, an analysis is performed on the output fusion data from the sensor fusion, where the analysis includes determining one or more potential actionable scenarios to be selected, where a scenario includes an operation of one or more resources, e.g., resources 150 of FIG. 1, in a way that is a potentially suitable response to the processed sensory information.

It should be noted that in an embodiment, more than one scenario may be used as a response to a particular collection of sensory inputs and that provides the best or most desirable response in a particular case. In some cases, the data from the sensor fusion indicates that the scenarios require a particular action and therefore at S340 it is checked whether an action is required and if so, execution continues with S350. In other cases, no action is deemed necessary, and execution continues with S370.

At S350, one or more scenarios are selected for action and at S360, commands and data are sent to those the resources that are used for the necessary response based on the scenario or scenarios determined to be most applicable. The scenario may include temporal responses, e.g., a first resource, for example resource 150-1 of FIG. 1 may provide an output earlier than another resource, for example resource 150-2 (not shown).

At S370, it is checked whether additional sensory inputs are to be gathered and if so, execution continues with S310; otherwise, execution terminates.

As an example implementation, in an embodiment, the sensor system 100 of FIG. 1, configured to perform the method shown in flowchart 300, uses sensors to identify a conversation occurring between two individuals. The sensor system 100 may be configured to determine the distance between the individuals conversing, to identify the kind of interaction occurring between the two, and to determine a need for an intervention.

In an embodiment, if it is determined that the conversation includes a debate regarding a certain fact, the system may be configured to intervene and provide a correct answer regarding that fact. If the debate is determined to be calm, it may require no intervention, while if it is determined that the debate is heated, an intervention may be deemed necessary or desirable.

For example, two individuals may be engages in a discussion, where one person argues that Turkey is in Europe while the other argues that Turkey is in Asia. As long as it can be determined that the participants are laughing about the subject and feel quite comfortable with each other, e.g., based on sensory information such as the audio captured by a microphone and video stream capture by cameras, the determination may be for no need for intervention. If, however, it is detected that one participant has changed from a seated to a standing position, and begins to raise the volume of their voice, change their vocal tone, and shift their demeanor, the determination of no intervention may be challenged. Based on an analysis of inputs captured by sensors, it can be determined that it is time for an intervention. For previously presented example, an intervention may include providing the answer ‘Turkey is on a peninsula referred to as Asia Minor.’ If it is determined that the two participants are laughing or returning to previously occupied seating positions, no additional intervention may be required.

One may further consider another way the sensor system 100 may respond. A message is received targeting one of multiple speakers recognized by the sensor system. A determination is made whether the received message is to be transferred to that person who is the primary user of the sensor system 100. For example, the sensor system 100 may be adapted to reading messages received by the primary user of the sensor system 100. Based on the interaction between the two users now present in the room, as well as the kind of content contained within the message, it may be determined to read or not to read the message out loud, e.g., through a loudspeaker. For example, if the message is determined to be a love message from a lover, it may be determined to refrain repeating it aloud before a stranger who has arrived at a location to deliver a package.

Conversely, if the received message is that the stock market is doing well today, which may be determined to be a neutral message in most scenarios, information from the received message, or the receive message itself, may be interjected into the conversation happening at the time.

In a further embodiment, the sensor system 100 is configured to determine ideal positioning of speakers in the proximity of the sensor system 100, perform an analysis of the interaction, as well as semantical analysis of verbal interaction, and then, based on the particular case observed, perform a response scenario based the particular case. This is done by using the resources available to the sensor system 100.

For example, it may be determined based on input data that an individual detected by the system has a hearing disability. Using a microphone sensor as well as potentially one or more cameras, it may be determined using models and algorithms, as discussed above in FIG. 2, that the position of a speaking individual relative to the hearing challenged person is less than optimal. An actionable scenario is selected, where the scenario includes an auditory or a visual response, e.g., activating an auditory resource such as a loudspeaker to play a recording requesting that the speaker stand at another place where the listener can better hear what is being said. Further, depending on the hearing challenged person's hearing frequency profile e.g., as previously determined and saved in a database for future reference, it may be suggested to further adjust volume or pitch.

In yet another example, the sensor system 100 is implemented within a vehicle where two individuals are conversing. The sensor system uses as sensory inputs a variety of sensors within the vehicle, including microphones, global positioning system (GPS) signals, and data provided from an internet-connected device within the vehicle, e.g., a smartphone, to determine the position of the vehicle at any given time. It may further be determined, based on the conversation between the individuals in the vehicle, current or potentially previously data, e.g., stored in memory, that pertains to a product that one of the individuals wishes to purchase. By comparing the position of the vehicle and data gathered through the internet-connected device, a response scenario that provides information to the relevant individual regarding a sale of the product wished to be purchased which is now on a sale and within a two minute detour from an original travel route. If it is further determined, based on the conversation, there is enough time to perform such a purchase, a resource is used, e.g., a loudspeaker, to inform the individuals that the product is available for purchase at a discount, as well as the time it would potentially take to reroute the vehicle. However, if the scenario of the individuals in the vehicle indicates displeasure of being late in reaching the intended destination, it may be determined to suppress such a suggestion and not provide such a scenario at that time.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing circuitrys (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining a responsive action based on sensor fusion, comprising:
performing a sensor fusion on data received from a plurality of sensors to produce output fusion data;
analyzing the output fusion data to determine one or more potential actionable scenarios to be selected;
determining if the one or more potential actionable scenarios are to be executed; and
sending commands to one or more resources to perform the one or more potential actionable scenarios.

2. The method of claim 1, wherein the sensor fusion further comprises:
applying predetermined models or algorithms that allow for an output of data having minimized uncertainty compared to the data received from the plurality of sensors.

3. The method of claim 1, wherein the plurality of sensors includes at least one of: an accelerometer, a temperature gauge, a humidity sensor, a microphone, a light sensitivity detector, and a camera.

4. The method of claim 1, wherein the sensor fusion is performed using a machine learning technique.

5. The method of claim 4, wherein the machine learning technique includes at least one of: a neural network, a recurrent neural network, decision tree learning, a Bayesian network, and clustering.

6. The method of claim 1, wherein the data received from a plurality of sensors includes data relating to a human-machine interaction.

7. The method of claim 1, wherein the data received from a plurality of sensors is data related to a conversation occurring between two individuals, and wherein the one or more potential actionable scenarios include an intervention in the conversation.

8. The method of claim 7, wherein the intervention includes providing instructions to an individual.

9. The method of claim 8, wherein the instructions include at least one of: an auditory instruction and a visual instruction.

10. A non-transitory computer readable medium having stored thereon instructions for causing a processing circuitry to perform a process, the process comprising:
performing a sensor fusion on data received from a plurality of sensors to produce output fusion data;
analyzing the output fusion data to determine one or more potential actionable scenarios to be selected;
determining if the one or more potential actionable scenarios are to be executed; and
sending commands to one or more resources to perform the one or more potential actionable scenarios.

11. A system for determining a responsive action based on sensor fusion, comprising:
a processing circuitry; and
a memory, the memory containing instructions that, when executed by the processing circuitry, configure the system to:
perform a sensor fusion on data received from a plurality of sensors to produce output fusion data;
analyze the output fusion data to determine one or more potential actionable scenarios to be selected;
determine if the one or more potential actionable scenarios are to be executed; and
send commands to one or more resources to perform the one or more potential actionable scenarios.

12. The system of claim 11, wherein the system is further configured to:
apply predetermined models or algorithms that allow for an output of data having minimized uncertainty compared to the data received from the plurality of sensors.

13. The system of claim 11, wherein the plurality of sensors includes at least one of: an accelerometer, a temperature gauge, a humidity sensor, a microphone, a light sensitivity detector, and a camera.

14. The system of claim 11, wherein the sensor fusion is performed using a machine learning technique.

15. The system of claim 14, wherein the machine learning technique includes at least one of: a neural network, a recurrent neural network, decision tree learning, a Bayesian network, and clustering.

16. The system of claim 11, wherein the data received from a plurality of sensors includes data relating to a human-machine interaction.

17. The system of claim 11, wherein the data received from a plurality of sensors is data related to a conversation occurring between two individuals, and wherein the one or more potential actionable scenarios include an intervention in the conversation.

18. The system of claim 17, wherein the system is further configured to:
provide instructions to an individual.

19. The system of claim 18, wherein the instructions include at least one of: an auditory instruction and a visual instruction.
